(19) United States
(12) Patent Application Publication
(10) Pub. No.: US 2011/0169622 A1
(43) Pub. Date: Jul. 14, 2011

(54) ENHANCED COMMUNICATION THROUGH VIBRATION

(75) Inventors: James A. Billmaier, Woodinville, WA (US); Kristopher C. Billmaier, Kirkland, WA (US)

(73) Assignee: Patent Navigation Inc., Woodinville, WA (US)

(21) Appl. No.: 12/837,665

(22) Filed: Jul. 16, 2010

Related U.S. Application Data
(60) Provisional application No. 61/226,282, filed on Jul. 16, 2009.

(51) Int. Cl. H04B 3/36

(52) U.S. Cl. 340/407.1

(57) ABSTRACT

A mobile communication device and/or the network by which it communicates may comprise logic to associate a specific vibration pattern to aspects of an outgoing call. The vibration pattern may be associated with one or more of an urgency, seriousness, or humorousness of the outgoing call, or with aspects of the information in the call such as font, style, color, punctuation, or symbols such as emoticons.

### PRIORITY CLAIM

This application claims priority under 35 U.S.C. 119 to U.S. application No. 61/226,282 filed on Jul. 16, 2009.

### TECHNICAL FIELD

The present disclosure relates to vibration technology for a mobile device.

### BACKGROUND

Thirty-five percent of spoken communication is conveyed in forms other than words. Pace, intensity, tonal inflections, and volume can all surround the spoken word to give the words more meaning. The effectiveness of written communication is enhanced through punctuation such as an exclamation mark, and more recently through emoticons (smiley face) or appended abbreviations (LOL, laugh out loud).

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1-2 are flow charts of embodiments of processes of associating vibrations with specific calls.

FIG. 3-4 are flow charts of embodiments of processes of associating vibrations with specific message aspects.

FIG. 5-6 are flow charts of embodiments of processes of creating vibration sequences.

FIG. 7 is a flow chart of an embodiment of a process of associating a vibrations with a specific call or message aspect.

FIG. 8 is a block diagram of an embodiment of an apparatus to carry out acts described herein.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information embodied in machine memories (including machine-readable media) and/or circuits that may be applied to influence the operation of a device. Software, hardware, and firmware embodied in machine memories and/or media are examples of logic. In general, logic may comprise combinations of software, hardware, and/or firmware.

Those skilled in the art will appreciate that logic may be distributed throughout one or more devices, and/or may be comprised of combinations of instructions in memory, processing and control circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic is a design decision that will vary according to implementation.

A mobile communication device and/or the network by which it communicates may comprise logic to associate a specific vibration pattern to an outgoing call. The vibration pattern may be associated with one or more of an urgency, seriousness, or humorousness of the outgoing call. A mobile communication device and/or the network by which it communicates may comprise logic to associate specific vibration patterns with one or more of punctuation, emoticons, font type and/or style, font color, or abbreviations. A mobile communication device and/or the network by which it communicates may comprise logic to convert one or more of text, voice, or audio information into a sequence of vibrations. The text may be converted to a sequence of vibrations as the text is selected from a touch screen. A mobile communication device and/or the network by which it communicates may comprise logic to convert one or more of a shaking or tapping motion into a vibration indication.

Text, symbols, and/or events as described above may be applied to translation logic, which outputs control signals to a vibration generator, to enhance communication through vibration. The vibration generator may be implemented using known techniques in the art, for example via voltage or current modulation to a piezo-electric crystal structure or an imbalanced motor drive.

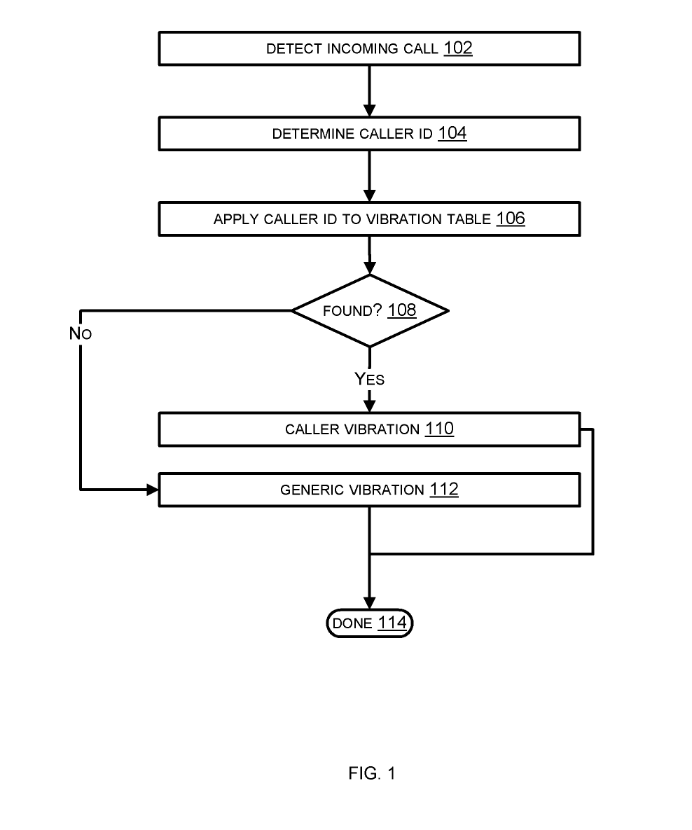

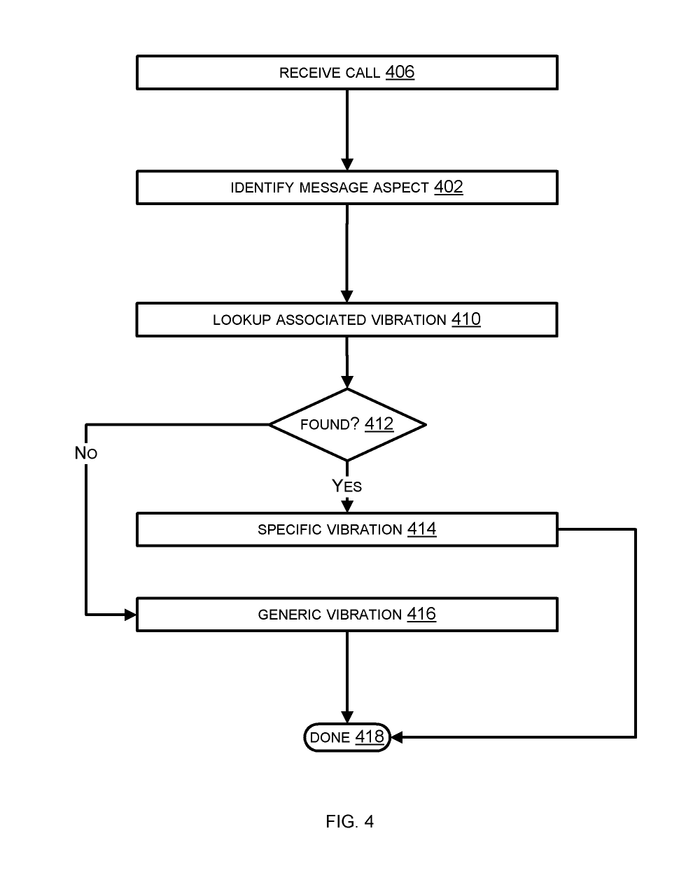

Note that in the following description in conjunction with FIG. 1-8, logic to enable certain features may be incorporated by the caller's device (e.g. a personal computer, laptop, cell phone, iPod™, etc, and/or by the device of the receiver of the call, and/or by intervening network equipment.

A vibration mechanism may be incorporated in cell phones and other mobile devices with communication capabilities, netbooks, tablet computers, notebooks, laptops, etc to enhance and in some cases replace the communication from sender to receiver.

Such devices and/or the networks by which they communicate may comprise logic to enable a user to assign a specific vibration pattern to the profile of a caller. When the caller calls, texts, emails, etc the user, a specific vibration is evoked. This allows the user to identify the caller without seeing a caller ID or hearing a ringtone. The analogy is assigning a ringtone to a caller for the purpose of IDing the caller. See FIG. 1.

An incoming call is detected 102 and a caller id determined 104. The caller id is applied to a vibration association table 106 (e.g. associative database logic) and if found (108), a specific vibration for the caller is generated 110. Otherwise a generic vibration is generated 112. The process then concludes 114.

Additionally, the user sending the text or making the call could assign themselves a specific relationship to the individual whom they contact, IE: Friend, Family, etc. A request for confirmation of this relationship would be sent prior to the user being added to that specific group.

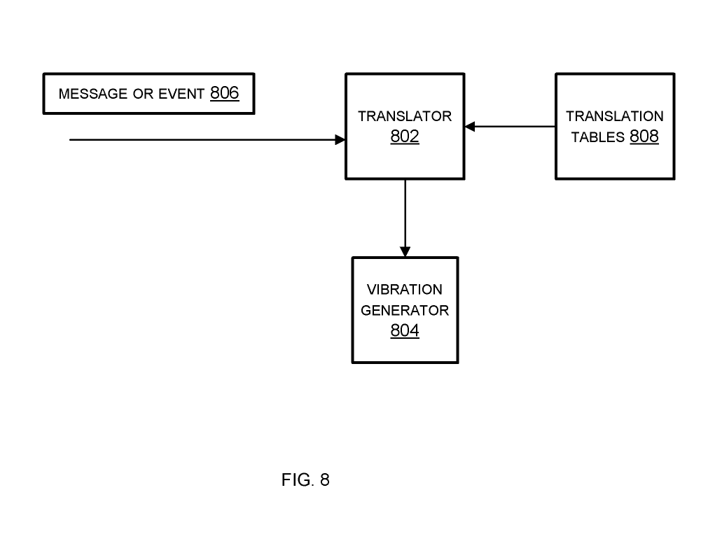

Vibration translation logic 802 may apply logic from one or more translation tables 808 (logic associating events, text features such as font or color or style, symbols, contact ids, and so on) to associate symbols, text, or events 806 with vibration patterns, intensities, durations, and timing (for example). The translator 802 may generate signals to a vibration generator 804. See FIG. 8.

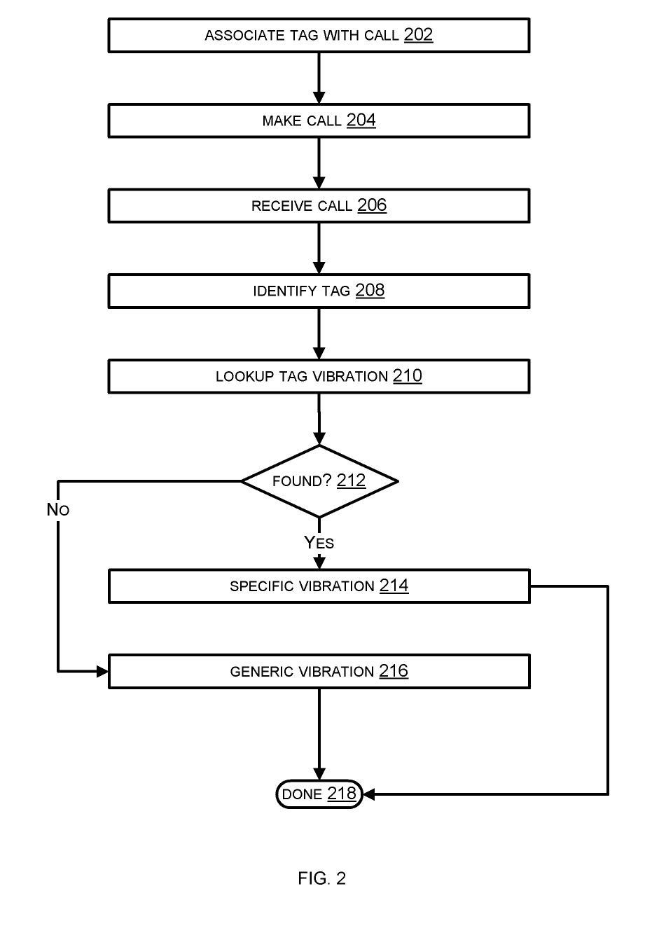

Devices and/or the networks by which they communicate may comprise logic to enable the caller to assign a specific vibration pattern to communicate the urgency, seriousness, humorousness, etc of a message. As an example, a very urgent call could invoke a hard pounding and continuous vibration. The user could allow, or disallow the device to inform him through vibration. The user making the call would also have the ability to “Tag” a call with a certain criteria set ie: urgent, humorous, low priority, that would be passed along to the individual to whom they are sending a text or calling. See FIG. 2.

A tag 202 may be associated with a call 204. When the call is received 206 the tag is identified 208 and an associated vibration is identified 210. If found 212 the specific vibration is generated 214, otherwise a generic vibration is generated 216. The process concludes 218.

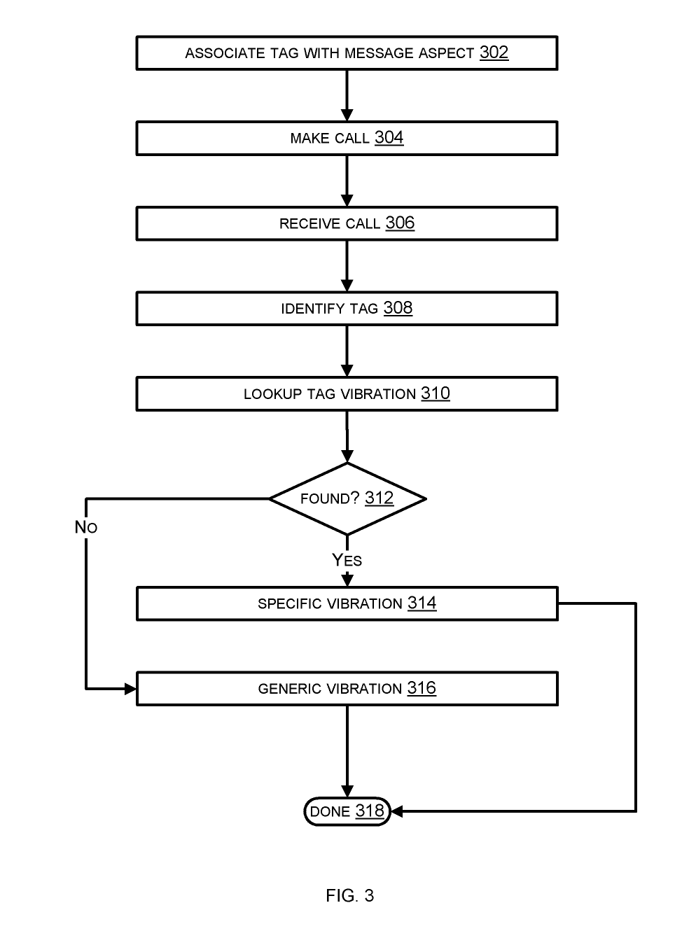

Devices and/or the networks by which they communicate may comprise logic to auto append enhanced vibration communication for punctuation, emoticons or abbreviations. The system (either device or server) would scan a text, email, or voice mail and attach an appropriate vibration pattern to advance communicate the tenor of the body of the message. See FIG. 3.

Devices and/or the networks by which they communicate may comprise logic to create and publish a series of vibration patterns (like a list of ringtones) with assigned meanings and or attached to a meaning. Emoticons would have an associated vibration pattern. Punctuation would have an associated vibration pattern. Meaningful abbreviations would have an associated vibration pattern. All caps or colored words would have an associated vibration pattern. See FIGS. 3 & 4.

A tag 302 may be associated with a message aspect 304. When the call is received 306 the tag is identified 308 and an associated vibration is identified 310. If found 312 the specific vibration is generated 314, otherwise a generic vibration is generated 316. The process concludes 318. A received call 406 may include a tag associated with a message aspect 402. The tag is identified and an associated vibration is identified 410. If found 412 the specific vibration is generated 414, otherwise a generic vibration is generated 416. The process concludes 418.

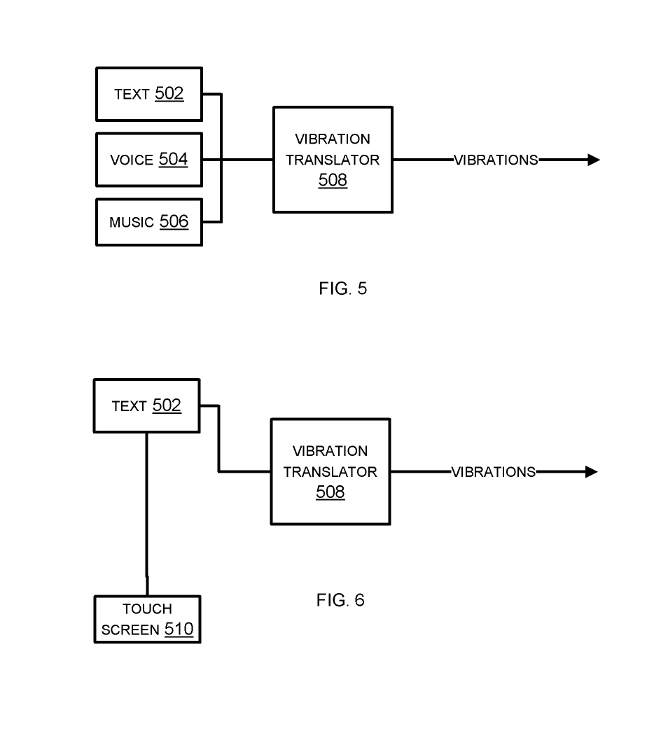

Devices and/or the networks by which they communicate may comprise logic to use vibration in place of language and/or to use a “vibration language” for sightless and soundless communication. Morris code would be a good proxy example. Regardless of the specific language replacement code, a translation of text to vibration, speech to vibration or music (any audio) to vibration could be enabled by the system. The vibration language would also be able to indicate tone from the user sending the message. IE: Serious, sarcastic. See FIG. 5.

Text 502, voice 504, or music 506 may all be applied to a vibration translator 508 to produce control signals for specific vibration patterns, intensities, duration, or timing.

A touchscreen 510 may produce text 502 that is applied to the vibration translator 508.

Devices and/or the networks by which they communicate may comprise logic to create and produce “vibration brail”. Sightless people could enable “vibration brail” which would convert the written text or email to vibrate the entire message from beginning to end. See FIG. 5. Or, the vibration could occur on the screen when a finger(hand) touches the screen area with that word. The human motion might look like a person reading traditional brail. See FIG. 6.

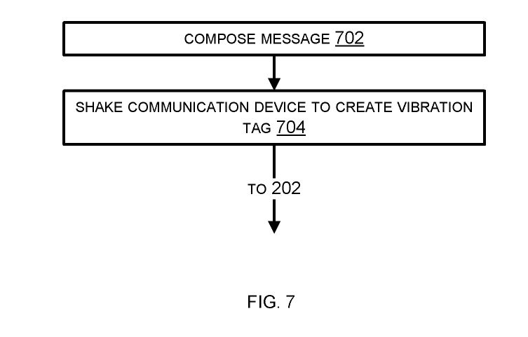

Devices and/or the networks by which they communicate may comprise logic to enable the user to create vibration or color enhancements to a message such as a text message, email, voice mail, etc by shaking or tapping the client device. For instance, after creating an instant message, urgency can be added to the message in the form of making the text red or adding more pronounced vibrations to the message by vigorously shaking or tapping the client device. See FIG. 7.

A message may be composed 702 and the device on which it is composed or which will communicate the message may be shaken 704 to create one or more vibration tags for the message or aspects of the message.

Those having skill in the art will appreciate that there are various logic implementations by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A mobile communication device comprising logic to associate a specific vibration pattern to an outgoing call.

2. The mobile device of claim 1, the vibration pattern associated with one or more of an urgency, seriousness, or humorousness of the outgoing call.

3. The mobile communication device of claim 1 comprising logic to associate specific vibration patterns with one or more of punctuation, emoticons, font type and/or style, font color, or abbreviations in the outgoing message.

4. A mobile communication device comprising logic to associate one or more of text, voice, or audio information in an outgoing message with a vibration pattern, intensity, duration, or timing.

5. The mobile device of claim 4, further comprising logic to associate vibrations with selections from a touch screen.

6. A mobile communication device comprising logic to convert one or more of a shaking or tapping motion into a vibration pattern identification associated with a message or with one or more aspects of the message.

7. A mobile communication network comprising logic to associate specific vibration patterns with one or more of punctuation, emoticons, font type and/or style, font color, or abbreviations in an incoming message.
